(19) United States
(12) Patent Application Publication
(10) Pub. No.: US 2010/0071599 A1
(43) Pub. Date: Mar. 25, 2010

(54) Stabilized Table and Method for Stabilizing a Table

(76) Inventor: Hugh Logan McEntire, St. Petersburg, FL (US)

Correspondence Address: SQUIRE, SANDERS & DEMPSEY L.L.P., 1 MARITIME PLAZA, SUITE 300, SAN FRANCISCO, CA, 94111, US

(21) Appl. No.: 12/236,448

(22) Filed: Sep. 23, 2008

(51) Int. Cl. A47B 13/00; F16M 11/00

(52) U.S. Cl. 108/50.11; 248/188.2

(57) ABSTRACT

A table has more than three legs, two of the legs being pivotable relative to the rest of the table. The pivotable legs are selectively locked against movement by a lock device that adjustably expands into contact with opposing control surfaces. One of the control surfaces is fixedly coupled to the pivotable legs and another one of the control surfaces is fixedly coupled to the rest of the table. Pivotal movement is prevented when the lock device is wedged against the opposing control surfaces. When the lock device is pulled out from between the control surfaces, the table can stabilize on an uneven floor surface, which may cause the opposing control surfaces shift in orientation relative to each other. A biasing member urges the lock device to self-expand and to automatically move into the same or different position between the opposing control surfaces as may be required to prevent subsequent movement.

### FIELD OF THE INVENTION

This invention relates generally to a table and a method for stabilizing a table on uneven ground.

### BACKGROUND OF THE INVENTION

A problem encountered with tables having more than three legs is that they wobble when the table is placed on uneven ground. Threaded feet have been used to address this problem. Threaded feet can be rotated to adjust the length of the legs or to accommodate an uneven floor surface. Rotational adjustment of the threaded feet is often inconvenient when it must be done repeatedly, such as when a table shifts slightly to another location on the uneven ground. In the case of sidewalk cafes, tables are routinely moved around during business hours and then stored away after business hours, which would require tables to be adjusted at least one or twice a day if the sidewalk is not very flat.

Usually only one of the feet on a four legged table needs to be adjusted, but rotational adjustment of threaded feet can be overly time consuming and usually requires a person to crouch down uncomfortably to rotate the feet. Because the threads of rotating feet are close to the ground, adjustment is often made difficult or impossible by trapped debris or oxidation due to water on the ground. Also, the threaded feet can become over-rotated in either the upward or downward directions, which requires several or all the feet to be readjusted in order to stabilize the table.

Even when placed on a perfectly flat floor surface, tables may also wobble when legs are slightly different in length due to slight manufacturing variations or when mechanical shifting, contraction, or bending occurs naturally over time in some parts of the table. Such wobbling creates a perception of low quality even though the table might have been manufactured with precision using materials of high quality. Accordingly, there is a need for a system and method of stabilizing a table that is relatively quick, convenient, and reliable.

### SUMMARY OF THE INVENTION

Briefly and in general terms, the present invention is directed to a table that can be stabilized on uneven ground. The table comprises a table top and four legs connected to the table top, the four legs including a first leg and a second leg that are adapted to simultaneously move in opposite vertical directions relative to the table top, there being an adjustable first gap between the first leg and the table top, there being an adjustable second gap between the second leg and the table top. The table further comprises a lock device adapted to wedge into the first and second gaps.

In other aspects of the present invention, a table comprises a top portion including a table top and a downward-facing surface. The table further comprises a bottom portion supporting the top portion, the bottom portion including a support assembly pivotally connected to the top portion. The support assembly includes a first leg, a second leg, and an upward-facing surface located at a distance below the downward-facing surface of the top portion. The first and second legs are adapted to simultaneously move in opposite vertical directions relative to the table top. The table further comprises a lock device adapted to move into contact with the upward-facing and downward-facing surfaces to limit movement of the first and second legs in the opposite vertical directions, and further adapted to pull out of contact from at least one of the upward-facing and downward-facing surfaces to allow movement of the first and second legs in the opposite vertical directions.

In some aspects of the present invention, the lock device is adapted to wedge into the first gap so as to engage the first leg to the table top and to wedge into the second gap so as to engage the second leg to the table top. In further aspects, the lock device is adapted to pull away from the first gap while remaining wedged into the second gap. In other further aspects, when the lock device is pulled away from the first gap while remaining wedged into the second gap, the second leg is adapted to move in a downward vertical direction while the first leg moves in an upward vertical direction.

In still further aspects, the lock device is adapted to pull away from the first and second gaps at the same time. In some aspects, the first and second legs are adapted to simultaneously move in the opposite vertical directions only when the lock device is pulled away from the first and second gaps at the same time.

In other aspects of the present invention, a method of stabilizing a table on uneven ground comprises collapsing a lock device, including moving the lock device at least partially out of a gap between a table top and a support assembly supporting the table top. The method further comprises pivoting the support assembly relative to the table top. The method may further comprise expanding the lock device, including moving the lock device into the gap until the lock device contacts a downward-facing surface and an upward-facing surface, the downward-facing and upward-facing surfaces defining the gap. In further aspects, the downward-facing surface is configured to move whenever the table top moves relative to the support assembly, and the upward-facing surface is configured to move whenever the support assembly moves relative to the table top.

The features and advantages of the invention will be more readily understood from the following detailed description which should be read in conjunction with the accompanying drawings.

### BRIEF DESCRIPTION OF THE DRAWINGS

FIG. 1 is a perspective view of a table capable of stabilizing on uneven ground.

FIG. 2 is an exploded view of the table of FIG. 1.

FIG. 3A-3B are front elevation views of the table of FIG. 1 after having been placed on an uneven floor surface.

FIG. 4 is a perspective view of a portion of a table showing a pivotable support assembly.

FIGS. 5A-5C are diagrams showing how a table with a pivotable support assembly at one end of the table may stabilize when the opposite end of the table is placed over uneven ground.

FIGS. 6A-6C are diagrams of the pivotable support assembly of FIGS. 5A-5C.

### DETAILED DESCRIPTION OF THE PREFERRED EMBODIMENTS

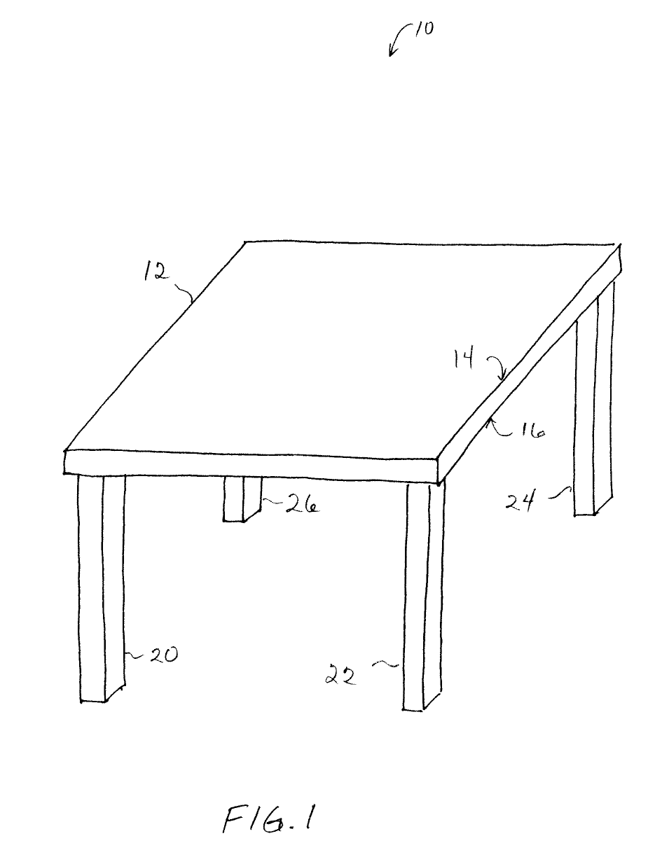

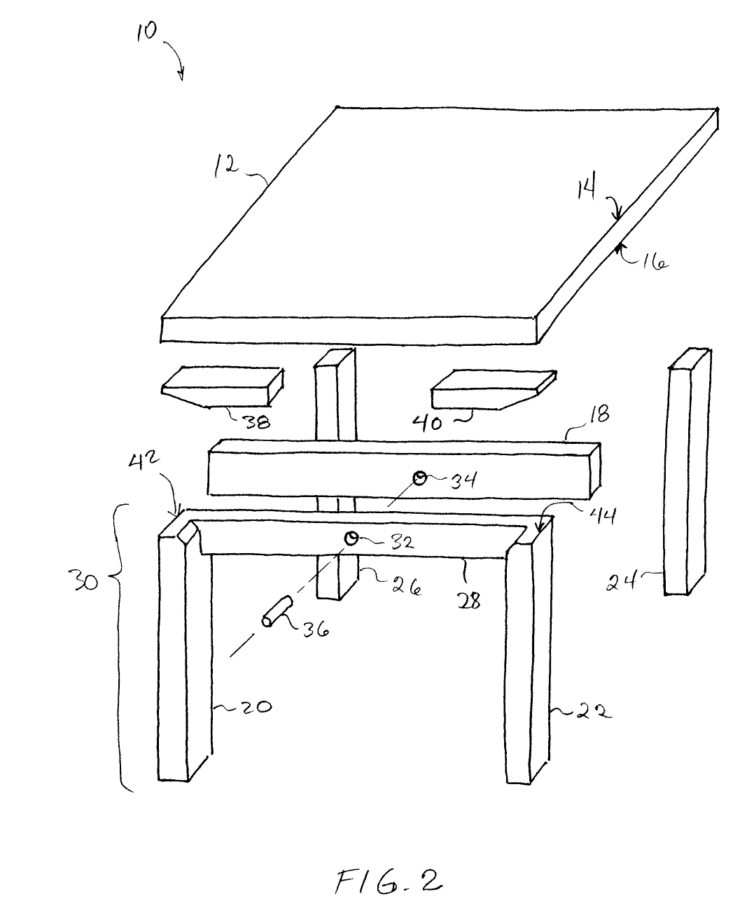

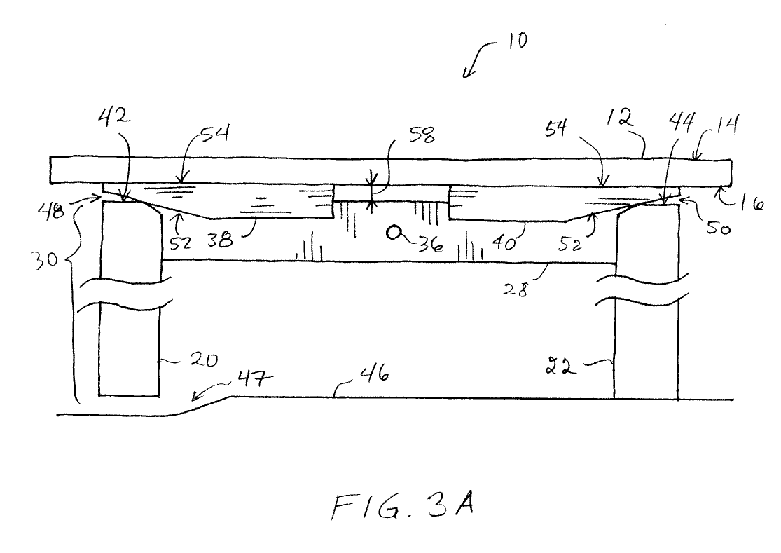

Referring now in more detail to the exemplary drawings for purposes of illustrating embodiments of the invention, wherein like reference numerals designate corresponding or like elements among the several views, there is shown in FIGS. 1 and 2 a table 10 for use on an uneven floor surface. When placed on a floor surface on which the table is unstable, temporary unlocking or manipulation of a lock device on the table allows a pair of legs to shift in position relative to the rest of the table, thereby allowing the table to assume a stable orientation. Locking of the lock device either limits or prevents subsequent pivoting of the pair of legs.

FIG. 2 is an exploded view of the table 10 showing a top portion and a bottom portion. The top portion includes a table top 12 having a top surface 14 and a bottom surface 16. The top portion further includes a mounting platform 18 that is fixedly attached to the bottom surface 16 in a manner that prevents the table top from moving independently of the mounting platform. In other embodiments, the mounting platform is an integral part of the table top 12.

The bottom portion of the table 10 includes four vertical legs 20, 22, 24, 26. The two rear legs 24, 26 are fixedly connected to the table top 12 and are incapable of moving vertically relative to the table top 12. The two front legs 20, 22 form part of a pivotable support assembly 30 that rocks or tilts relative to the rear legs 24, 26. The two front legs 20, 22 are fixedly connected to each other by a horizontal rocker member 28 so as to allow the two front legs to simultaneously move in opposite vertical directions relative to the table top. That is, when one if the two front legs moves vertically upward, the other one of the two front legs simultaneously moves vertically downward.

The rocker member 28 is pivotally mounted to the mounting platform 18 to allow the two front legs 20, 22 to pivot about a plane that is perpendicular or roughly perpendicular to the table top. Holes 32, 34 are formed through the rocker member 28 and the mounting platform 18 and are sized to accept the cylindrical shank of a pivot member 36. The holes 32, 34 are aligned in such a way so that there will be a clearance or gap between the bottom surface 16 of the table top 12 and the top of the two front legs 20, 22. In particular, there are two gaps 48, 50, one on each side of the pivot member 36. The gaps are filled by a lock device comprising two lock members 38, 40 in the shape of wedges with tapered surfaces configured to wedge in between the downward-facing bottom surface 16 of the table top and the upward-facing surfaces 42, 44 above the two front legs 20, 22. The downward-facing bottom surface 16 move whenever the table top 12 moves relative to the support assembly 30. Also, the upward-facing surfaces 42, 44 move whenever the support assembly 30 moves relative to the table top 12.

The opposing or oppositely facing surfaces 16, 42, 44 function as control surfaces which can selectively limit and allow pivotal movement of the two front legs 20, 22 relative to the rest of the table. In operation, the orientation of the upward-facing surfaces 42, 44 relative to the downward-facing surface 16 will vary depending upon the amount of pivoting or tilt required of the two front legs in order to have all legs resting firmly on the floor surface. Once all legs are resting firmly on the floor surface, the orientation of the upward-facing surfaces 42, 44 relative to the downward-facing surface 16 can be fixed or held constant by the lock members 38, 40 in order to prevent or limit the table top from tilting thereafter.

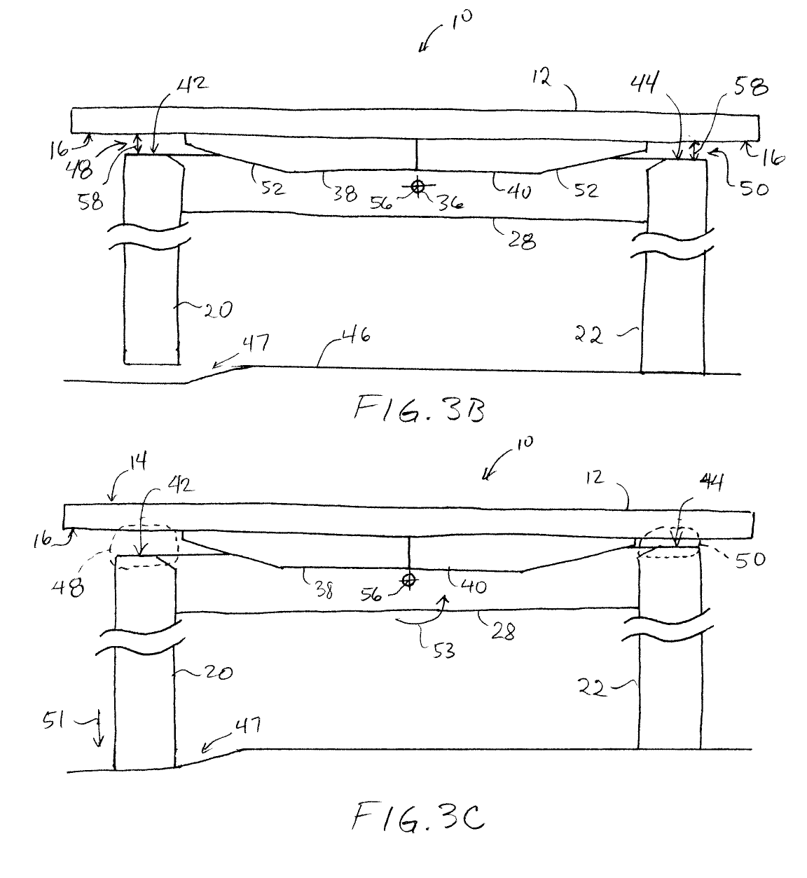

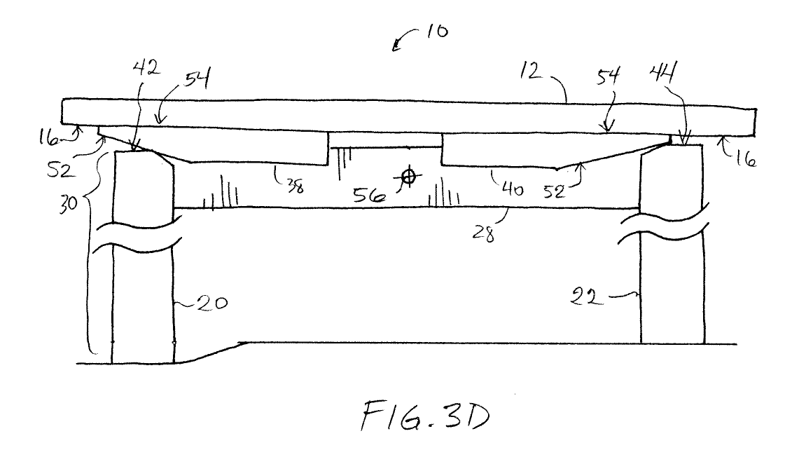

FIG. 3A shows a front view of the table 10 of FIG. 2 when assembled and placed on an uneven floor surface 46. The table 10 is unstable since all but the left front leg are touching the floor surface. The lock device, comprising the two lock members 38, 40, is shown in an expanded orientation in FIG. 3A. The two front legs 20, 22 are prevented from rocking or moving vertically relative to the table top 12 because of the two lock members 38, 40 that extend within the gaps 48, 50 at opposite sides of the pivot member 36. Pivotal movement of the two front legs 20, 22 is either limited or prevented since tapered surfaces 52, 54 of the lock members 38, 40 are in tight contact with the upward-facing surfaces 42, 44 located above the two front legs 20, 22 and the downward-facing bottom surface 16 of the table top 12.

In FIG. 3A, the rocker member 28 is parallel to the bottom surface 12 so there is a uniform clearance 58 between the rocker member and the bottom surface. The gaps 48, 50 are equal in height and the bottom of the two front legs 20, 22 are at equal distances from the bottom surface 12 of the table top 12. With the lock members 38, 40 wedged tightly in the gaps 48, 50, the entire table 10 may wobble in such a way that the right rear leg 24 will lift up off the floor surface 46 whenever the left front leg 20 drops into the depression 47 in the floor surface 46.

FIG. 3B shows the table 10 after the lock device has been reduced in size to a collapsed orientation from its initial expanded orientation in FIG. 3A. In the collapsed orientation, the opposite ends of the of the lock device, namely the tapered tips of the two lock members 38, 40, are closer to each other than when in the expanded orientation. To collapse the lock device, the two lock members 38, 40 are moved horizontally toward each other, causing the tapered tips to move out of the gaps 48, 50 directly above the two front legs 20, 22. When the tapered surfaces 52 are out of contact with the upward-facing surfaces 42, 44 above the front legs, the rocker member 28 and the front legs are free to pivot about a pivot point 56 centered on the pivot member 36.

With the gaps 48, 50 located at opposite sides of the pivot point 56, one of the gaps will increase in size while the other gap will simultaneously decreases in height whenever pivotal movement of the two front legs 20, 22 occurs. Since the two front legs 20, 22 are attached to the rocker member 28 at opposite sides of the pivot point 56, pivotal movement of the front legs will cause one of the front legs to move vertically downward while the other front leg will simultaneous move vertically upward. In the case of FIG. 3B, the weight of the table 10 at the pivot point 56 will push the left front leg 20 downward into contact with the floor surface 46.

The amount by which the left front leg 20 is free to move downward below the right front leg 22 depends upon the uniform clearance 58 as measured when the rocker member 28 is parallel to the bottom surface 16 of the table top 12. The left front leg 20 is capable of moving down until the upward-facing surface 44 engages the bottom surface 12. For example, when the hole 32 in the rocker member 28 and the hole 34 in the mounting panel 18 are aligned in such a way that there is a uniform clearance of one eighth inch (about 3 mm), the left front leg 20 can move down by about one eighth inch while the right front leg 24 moves up by the same amount, assuming that the pivot point 56 is centered between the two front legs. Stated another way, the left front leg 20 can move one quarter inch (about 6 mm) below the right front leg 22. Thus, the table 10 will be able to stabilize on a floor surface with a depression that is twice that of the uniform clearance 58 between the rocker member 28 and the bottom surface 16 of the table top. It will be appreciated that any uniform clearance can be used as may be desirable for the size of table and type of floor surface expected to be encountered.

In FIG. 3C, the weight of the table 10 has caused the table to self-stabilize, as indicated by arrows 51, 53, after the two lock members 38, 40 have been moved out of the gaps 48, 50. The left front leg 20 has dropped down into the depression 47 while the right front leg 22 has moved up closer to the table top 12. Also, the front of the table has dropped slightly compared to the rear of the table which remains firmly supported by the two rear legs 24, 26 in contact with the floor surface 46. Also, the gap 48 adjacent the left front leg 20 has increased in height while the gap 50 adjacent the right front leg 22 has simultaneously decreased in height.

With the lock device still in its collapsed orientation in FIG. 3C, the table 10 is like a three-legged table supported at three points. The table top 12 is supported above the two rear legs 24, 26 and above the pivot point 56. There is no direct support above the two front legs 20, 22 because the lock members 38, 40 are no longer engaging the top of the front legs 20, 22 to the table top 12. As such, additional weight placed near one of the two front corners of the table top may cause the table top to tilt about the pivot point 56.

In FIG. 3D, the table 10 has been stabilized further by returning the lock device to its expanded orientation. The tapered surfaces 52, 54 of the lock members 38, 40 are again in tight contact with the upward-facing surfaces 42, 44 of the pivotable support assembly 30 and the downward-facing bottom surface 16 of the table top 12. In this configuration, all of the legs are in contact with the floor surface and provide four points of support to the table top 12.

The lock members 38, 40 in FIG. 3D are off-center from the pivot point 56, instead of being centered about or equidistant from the pivot point 56 as shown in FIG. 3A. This horizontal, off-center position occurs because the lock members 38 are positioned to accommodate the difference in the heights of the gaps 48, 50 adjacent the front legs 20, 22. Compared to FIG. 3A, the left lock member 38 in FIG. 3D is positioned further away from the pivot point 56 in order to fill the larger sized gap 48 adjacent the left front leg 20. Also in comparison with FIG. 3A, the right lock member 40 in FIG. 3D is positioned closer to the pivot point 56 due to the smaller sized gap 50 adjacent the right front leg 22.

In the illustrated embodiment of FIG. 3D, the opposing control surfaces 16, 42, 44 and the lock members 38, 40 are located directly above the two front leg 20, 22, as opposed to being closer to the pivot point 56, in order to provide a high degree of stability to the table top. The upward-facing control surfaces 42, 44 also include a bevel or ramped portion that may guide or make it easier for the lock members 38, 40 to wedge in between the opposing control surfaces 16, 42, 44.

In other embodiments, lock device is biased to automatically return to its expanded orientation at the appropriate horizontal position relative to gaps 48, 50 and the pivot point 56.

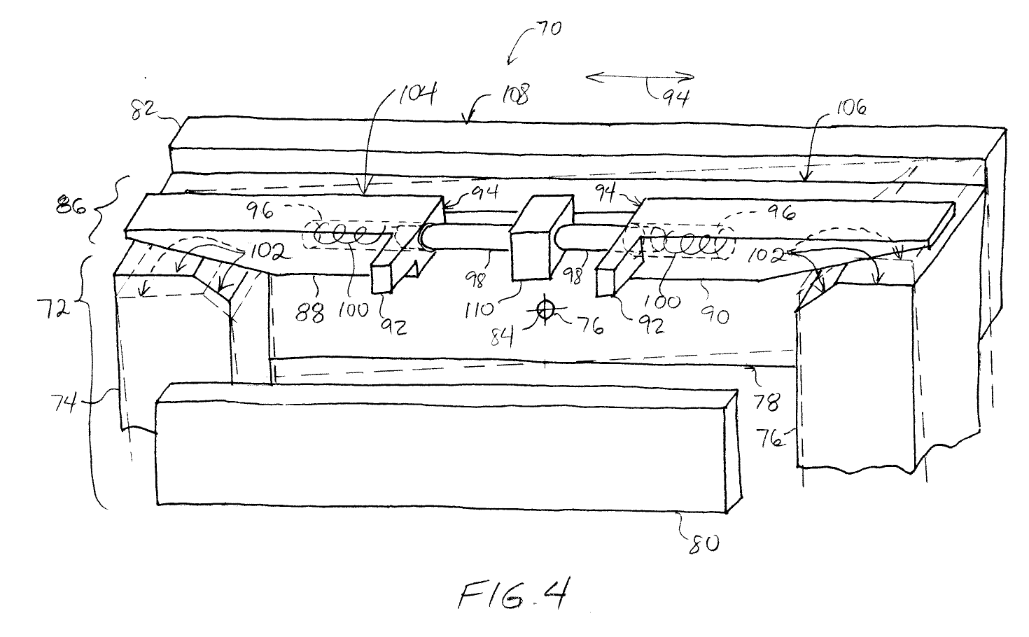

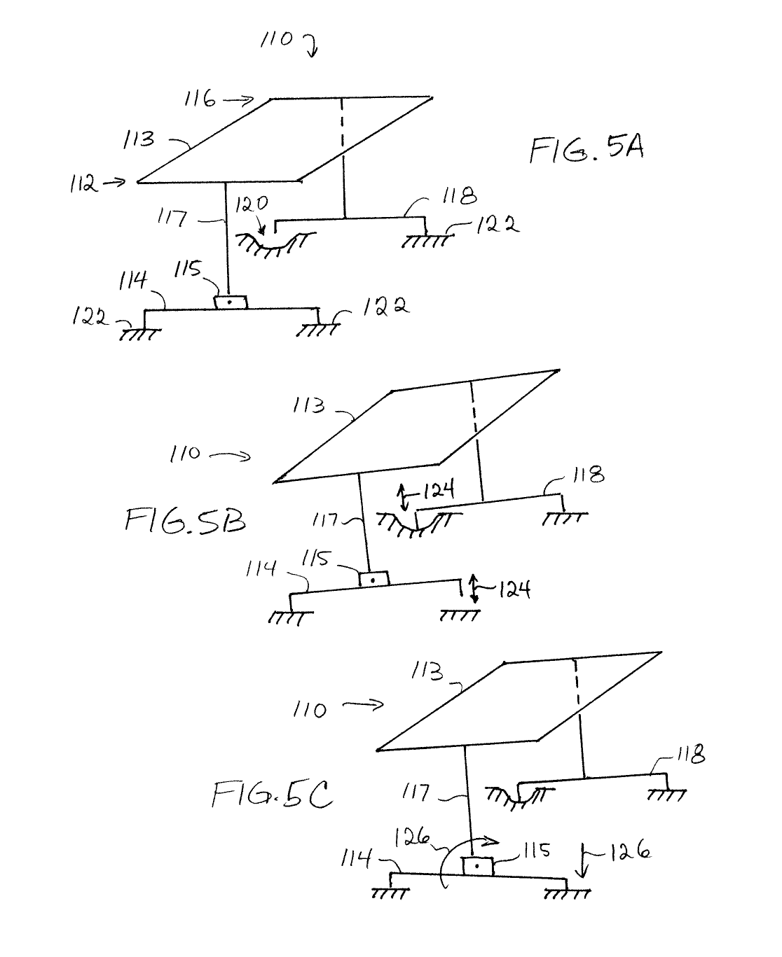

FIG. 4 shows a portion of a table 70 with its table top removed to expose a pivotable support assembly 72 for supporting the table top. The support assembly 72 includes a left end 74, a right end 76, and a rocker member 78 rigidly connecting the left and right ends together. The support assembly 72 also includes a cover plate 80 which in FIG. 4 has been disconnected and pulled away from the rest of the support assembly to better show other parts of the support assembly. The cover plate 80 would normally be located between the two ends 74, 76. In some embodiments, the two ends 74, 76 are fixedly connected to table legs or a support structure intended to rest upon a floor surface. The support structure may extend in outward horizontal directions 94 away from the two ends, such as shown in FIGS. 5A-5C for example.

Referring again to FIG. 4, the support assembly 72 is connected to the table top by a mounting plate 82 behind the support assembly. The mounting plate 82 has a cylindrical protrusion 76 that extends through a circular hole formed in the rocker member 78. In operation, the rocker member 78 and the two ends 74, 76 pivot relative to the mounting plate 82. Pivoting occurs about a center point 84 centered on the protrusion 76.

A locking device 86 is manipulated to control the pivoting motion of the support assembly 72. The locking device 86 includes a left lock member 88 and a right lock member 90, both of which include levers 92 for moving the lock members in horizontal directions 94. The levers 90 are sized to allow a person to move the lock members independently of each other, as explained below.

The locking device 86 includes two opposing surfaces 94 into which a blind hole 96 is formed. A push rod 98 extends partially inside the blind holes 96. A compression spring 100 is retained inside each of the lock members 88, 90 and is trapped in between the push rod 98 and the bottom end of each blind hole 96. The two springs 100 bias or urge the locking device 86 to expand outwardly towards the ends 74, 76 of the pivotable support assembly 72. The springs 100 provide constant pressure on the lock members 88, 90, pushing the lock members away from the pivot point 84 and into contact with the upward-facing control surfaces 102 at opposite sides of the pivot point 84.

When assembled, a downward-facing control surface (not shown) of a table top, or other portion of the table connected to the table top, is in sliding contact with the top surfaces 104, 106 of the lock members and is fixedly attached to the top surface 108 of the mounting plate 82. In operation, a person may squeeze the two levers 92 together in order to disengage the lock members 88, 90 from the upward-facing control surfaces 102, thereby allowing the support assembly 72 to tilt in order to stabilize the table 70. When squeezing, the lock members 88, 90 slide toward each other until they come to rest against a stop block 110 disposed between the lock members. The stop block 110 is fixedly attached to the mounting plate 82 at a horizontal position that ensures that the lock members 88, 90 are pulled completely out of the gaps formed between upward-facing control surfaces 102 and the downward-facing control surface (not shown).

When the lock members 88, 90 are in a collapsed orientation and positioned away from the control surface 102, the support assembly 72 is capable of pivoting to allow the table 70 to stabilize itself by its own weight. For example, the upward-facing control surface 102 to the left of the pivot point 84 may move downward while the upward-facing control surface 104 to the right of the pivot point 84 may move upward, as indicated by the broken lines in FIG. 4. After the table has stabilized, the levers 92 can be released to allow the lock members 88, 90 to automatically expand and lock the pivotable support assembly 72 against movement relative to the rest of the table. The lock members 88, 90 will be pushed by the springs 100 away from the stop block 110. Consequently, the lock members will move outward until they are wedged in between the upward-facing control surfaces 102 and an opposing downward-facing surface of a table top or other structure fixedly coupled to the table top. If the gap above the left upward-facing control surface 102 increases in height during stabilization, the left lock member 88 will horizontally move beyond its original position in order to fill the larger gap and, thereby, lock the support assembly 72 in place. The springs 100 enable the lock members 88, 90 to automatically find the correct horizontal position to lock the support assembly 72.

It is to be understood that a table having a pivotable support assembly according to the present invention is capable of stabilizing even when a depression on a floor surface is present over a table leg that is not part of the pivotable support assembly.

FIGS. 5A-5C show a table 110 that that is supported at opposite ends. The front end 112 of the table top 113 is supported by a support 114 movable relative to the table top. The movable support 114 is capable of pivoting relative to the table top 113 by means of a pivotable support assembly 115. In particular, the pivotable support assembly 115 pivotally connects the movable support 114 to a mounting member 117 that is fixedly connected to the table top 113. The mounting member 117 moves in the same general direction whenever the table top 113 is moved. The rear end 116 of the table is supported by a fixed support 118 that is incapable of pivoting relative to the table top.

As shown in FIG. 5A, the fixed support 118 is positioned over a depression 120 in the floor surface 122. As shown in FIG. 5B, the depression 120 allows the table to wobble or tilt back and forth, as indicated by arrows 124. Causing part of the fixed support 118 to lower into the depression 120 will also cause part of the movable support 114 to lift up above the floor surface 122. As shown in FIG. 5C, unlocking a lock device in the pivotable support assembly 115 allows the movable support 114 to rotate in the direction of arrows 126. The weight of the table pushes all parts of the movable and fixed supports 114, 118 into contact with the floor surface 122, thereby allowing the table 110 to stabilize itself.

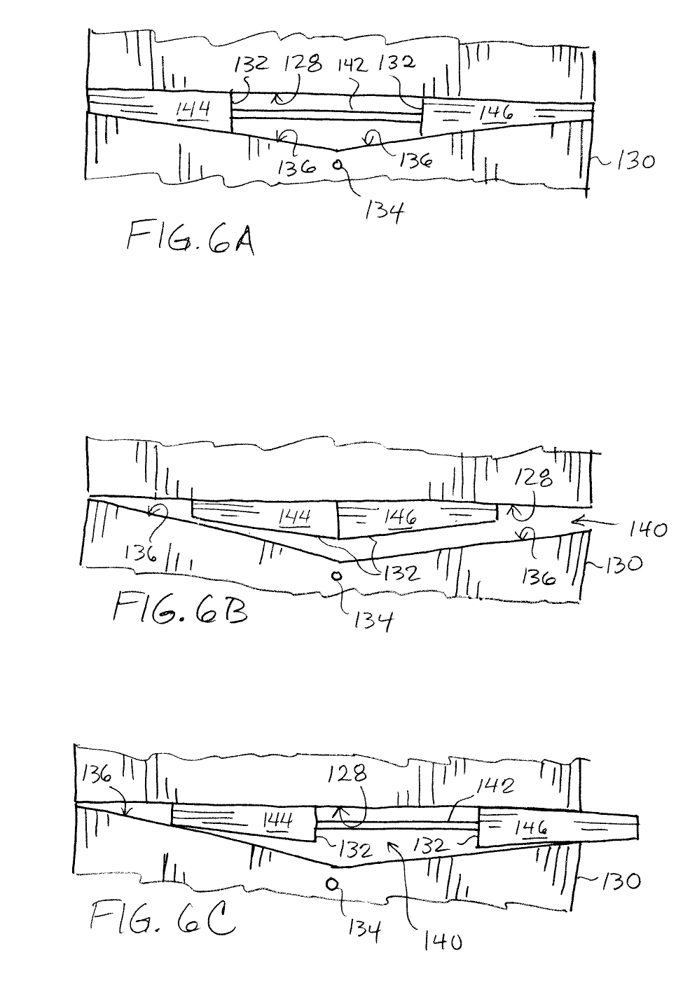

FIGS. 6A-6C show a diagrammatic view of a portion of the pivotable support assembly 115 of FIGS. 5A-5C. The pivotable support assembly 115 includes a downward-facing surface 128, a rocker member 130, and a collapsible locking device 132. The downward-facing surface 128 is coupled to the table top 113 in manner that prevents the surface 128 from moving independently of the table top. The rocker member 130 is pivotally coupled to the mounting member 128 to allow rotation of the movable support 114 (FIGS. 5A-5C) about a pivot 134. The rocker member 130 includes upward-facing control surfaces 136. The upward-facing and downward-facing control surfaces 136, 128 define a gap 140 in which the locking device 132 is able to collapse, expand, and change position to allow the table to stabilize in response to changing ground conditions or deflection in other table parts. The locking device 132 includes a biasing device 142 disposed between two opposing lock members 144, 146. The biasing device 142 is under compression and is adapted to constantly push the lock members apart and into engagement with the upward-facing and downward-facing control surfaces 136, 128. Examples of biasing devices include without limitation torsion springs, coil springs, gas springs, or other structures capable storing energy when deflected. Biasing devices can also include electrically or pneumatically controlled devices.

In other embodiments, a locking device can be selectively held in a collapsed position and/or in an expanded position by detents formed in other parts of the support assembly, or by screws, latches, and conventional means of temporarily fixing the position of a moving part.

While several particular forms of the invention have been illustrated and described, it will also be apparent that various modifications can be made without departing from the scope of the invention. For example, a table can include two pivotably support assembly to allow a table with four or more legs to stabilize. It is also contemplated that various combinations or subcombinations of the specific features and aspects of the disclosed embodiments can be combined with or substituted for one another in order to form varying modes of the invention. Accordingly, it is not intended that the invention be limited, except as by the appended claims.

What is claimed is:

1. A table that can be stabilized on uneven ground, the table comprising:
a table top;
four legs connected to the table top, the four legs including a first leg and a second leg that are adapted to simultaneously move in opposite vertical directions relative to the table top, there being an adjustable first gap between the first leg and the table top, there being an adjustable second gap between the second leg and the table top; and
a lock device adapted to wedge into the first and second gaps.

2. The table of claim 1, wherein the lock device is adapted to wedge into the first gap so as to engage the first leg to the table top and to wedge into the second gap so as to engage the second leg to the table top.

3. The table of claim 1, wherein the first gap is defined by a first control surface and a second control surface, the first control surface moving relative to the second control surface whenever the first and second legs simultaneously move in the opposite vertical directions.

4. The table of claim 3, wherein the lock device is adapted to selectively limit and allow movement of the first and second control surfaces relative to each other.

5. The table of claim 3, wherein the lock device has a collapsed orientation and an expanded orientation, the lock device being out of contact with at least one of the first and second control surfaces when in the collapsed orientation, the lock device being in contact with the first and second control surfaces when in the expanded orientation.

6. The table of claim 1, wherein the lock device includes a first lock member adapted to move within the first gap and a second lock member adapted to move within the second gap, the first and second lock members adapted to move independently of each other.

7. The table of claim 1, wherein when the lock device is not wedged into the first and second gaps, the first and second legs pivot about a common pivot point located between the first and second legs.

8. The table of claim 7, wherein the lock device includes a first lock member adapted to move within the first gap and a second lock member adapted to move within the second gap, the first and second lock members located at opposite sides of the pivot point.

9. A table that can be stabilized on uneven ground, the table comprising:
a top portion including a table top and a downward-facing surface;
a bottom portion supporting the top portion, the bottom portion including a support assembly pivotally connected to the top portion, the support assembly including a first leg, a second leg, and an upward-facing surface located at a distance below the downward-facing surface of the top portion, the first and second legs adapted to simultaneously move in opposite vertical directions relative to the table top; and
a lock device adapted to move into contact with the upward-facing and downward-facing surfaces to limit movement of the first and second legs in the opposite vertical directions, and further adapted to pull out of contact from at least one of the upward-facing and downward-facing surfaces to allow movement of the first and second legs in the opposite vertical directions.

10. The table of claim 9, wherein the downward-facing surface moves whenever the table top moves relative to the first and second legs, and the upward-facing surface moves whenever the first and second legs move relative to the table top.

11. The table of claim 9, wherein simultaneous movement of the first and second legs in the opposite vertical directions changes the orientation of the upward-facing surface relative to the downward-facing surface.

12. The table of claim 9, wherein:
the upward-facing surface includes a first upward-facing surface adjacent the first leg and a second upward-facing surface adjacent the second leg;
the downward-facing surface includes a first downward-facing surface adjacent the first leg and a second downward-facing surface adjacent the second leg; and
the lock device includes a first lock member and a second lock member movable relative to the first lock member, the first lock member adapted to wedge into contact with the first upward-facing and first downward-facing surfaces, the second lock member adapted to wedge into contact with the second upward-facing and second downward-facing surfaces.

13. The table of claim 9, wherein when the lock device is out of contact from at least one of the upward-facing and downward-facing surfaces, the lock device is biased to automatically wedge into contact with the upward-facing and downward-facing surfaces.

14. The table of claim 9, wherein when the lock device is out of contact from at least one of the upward-facing and downward-facing surfaces, the first and second legs pivot about a common pivot point located between the first and second legs.

15. The table of claim 14, wherein the lock device includes a first lock member and a second lock member, the first and second lock members biased to move in opposite directions away from the pivot point.

16. The table of claim 14, wherein:
the upward-facing surface includes a first upward-facing surface and a second upward-facing surface, the first and second upward-facing surfaces located at opposite sides of the pivot point;
the downward-facing surface includes a first downward-facing surface and a second downward-facing surface, the first and second downward-facing surfaces located at opposite sides of the pivot point; and
the lock device includes a first end portion and a second end portion opposite the first end portion, the first end portion adapted to wedge into contact with the first upward-facing and first downward-facing surfaces, the second end portion adapted to wedge into contact with the second upward-facing and second downward-facing surfaces.

17. The table of claim 9, wherein the lock device is movable between a collapsed orientation and an expanded orientation, the lock device being in contact with the upward-facing and downward-facing surfaces when in the expanded orientation, the lock device being out of contact from at least one of the upward-facing and downward-facing surfaces when in the collapsed orientation.

18. A method of stabilizing a table on uneven ground, the method comprising:
collapsing a lock device, including moving the lock device at least partially out of a gap between a table top and a support assembly supporting the table top;
pivoting the support assembly relative to the table top; and
expanding the lock device, including moving the lock device into the gap until the lock device contacts a downward-facing surface and an upward-facing surface, the downward-facing and upward-facing surfaces defining the gap, the downward-facing surface configured to move whenever the table top moves relative to the support assembly, the upward-facing surface configured to move whenever the support assembly moves relative to the table top.

19. The method of claim 18, wherein pivoting the support assembly includes simultaneously moving two table legs in opposite vertical directions relative to the table top.
